(19) United States
(12) Patent Application Publication
(10) Pub. No.: US 2026/0153889 A1
(43) Pub. Date: Jun. 4, 2026

(54) CLEANING DEVICE, CONTROL METHOD FOR CLEANING DEVICE AND RELATED DEVICE

(71) Applicant: Beijing Roborock Innovation Technology Co., Ltd., Beijing (CN)

(72) Inventors: Lina CAO, Beijing (CN); Zhe LI, Beijing (CN); Baoyu LI, Beijing (CN)

(21) Appl. No.: 19/459,170

(22) Filed: Jan. 26, 2026

Related U.S. Application Data
(63) Continuation of application No. PCT/CN2024/116941, filed on Sep. 4, 2024.

(30) Foreign Application Priority Data
Aug. 29, 2023 (CN) 202311101672.7

(51) Int. Cl. G05D 1/80; A47L 11/40; G05D 1/242; G05D 1/245; G05D 1/246; G05D 105/10

(52) U.S. Cl. CPC G05D 1/80; A47L 11/4002; A47L 11/4011; A47L 11/4091; G05D 1/242; G05D 1/245; G05D 1/246; G05D 2105/10

(57) ABSTRACT

Disclosed are a cleaning device, a control method for the cleaning device, and a related device. The control method includes: in response to a map correction instruction, acquiring a current operation state of the cleaning device; and in a case where the cleaning device is in a stationary state, correcting map information to acquire corrected map information.

### CROSS-REFERENCE TO RELATED APPLICATIONS

The present disclosure is a Continuation Application of PCT Application No. PCT/CN 2024/116941, filed on Sep. 4, 2024, which is based on and claims priority to Chinese Patent Application No. 202311101672.7, filed on Aug. 29, 2023, the entire contents of both of which are incorporated herein by reference.

### TECHNICAL FIELD

Embodiments of the present disclosure relate to the field of cleaning device technologies, and in particular to, a cleaning device, a control method for the cleaning device and a related device.

### BACKGROUND OF THE INVENTION

As technology advances, cleaning robots have seen widespread adoption across industrial, commercial, and residential settings.

### SUMMARY OF THE INVENTION

In a first aspect of the present disclosure, a control method for a cleaning device is provided.

In a second aspect of the present disclosure, a computer-readable storage medium is provided.

In a third aspect of the present disclosure, a cleaning device is provided.

In a fourth aspect of the present disclosure, a cleaning system is provided.

In view of this, according to a first aspect of embodiments of the present disclosure, a control method for a cleaning device is proposed. The control method for the cleaning device includes:
in response to a map correction instruction, acquiring a current operation state of the cleaning device; and
in a case where the cleaning device is stationary, correcting map information to acquire corrected map information.

According to a second aspect of embodiments of the present disclosure, a computer-readable storage medium is proposed.

The computer-readable storage medium stores a computer program to implement the control method according to any of the above technical solutions.

According to a third aspect of embodiments of the present disclosure, a cleaning device is proposed. The cleaning device includes:
a memory, configured to store a computer program; and
a processor, configured to execute the computer program, wherein
the processor, when executing the computer program, implements the control method according to any of the above technical solutions.

According to a fourth aspect of embodiments of the present disclosure, a cleaning system is proposed. The cleaning system includes:
the cleaning device according to the above technical solution; and
a cleaning base station that provides maintenance for the cleaning device.

### BRIEF DESCRIPTION OF DRAWINGS

Various other advantages and benefits will become apparent to those of ordinary skill in the art upon reading the following detailed description of preferred embodiments. The accompanying drawings are only for the purpose of illustrating preferred embodiments and should not be considered as limitations on the present disclosure. In addition, throughout the accompanying drawings, the same reference signs denote the same components. In the accompanying drawings:

FIG. 1 is a schematic step flowchart of a control method for a cleaning device according to an embodiment of the present disclosure;

FIG. 2 is a schematic step flowchart of a control method for a cleaning device according to another embodiment of the present disclosure;

FIG. 3 is a structural block diagram of a computer-readable storage medium according to an embodiment of the present disclosure; and

FIG. 4 is a structural block diagram of a cleaning device according to an embodiment of the present disclosure.

### DETAILED DESCRIPTION

In order to better understand the above technical solutions, the technical solutions of embodiments of the present disclosure are described in detail below through the accompanying drawings and the specific embodiments, and it should be understood that the embodiments of the present disclosure and specific features in the embodiments are detailed descriptions of the technical solutions of the embodiments of the present disclosure, and are not the limitations on the technical solutions of the present disclosure. Without conflict, the embodiments of the present disclosure and the technical features in the embodiments may be combined with each other.

As technology advances, cleaning robots have seen widespread adoption across industrial, commercial, and residential settings. However, cleaning robots in traditional technologies are prone to some map drift due to sensor errors during map construction, causing inconsistency between the map and a real scenario. In some specific scenarios, the map drifts greatly, significantly compromising subsequent positioning and navigation. Therefore, the cleaning robots in traditional technologies must construct and optimize the map simultaneously. In addition, this real-time computation demands substantial computing power, as it must optimize the map while maintaining real-time positioning. Consequently, this method is only feasible in cleaning robots with high-performance processors, which greatly increases the costs of the cleaning robots.

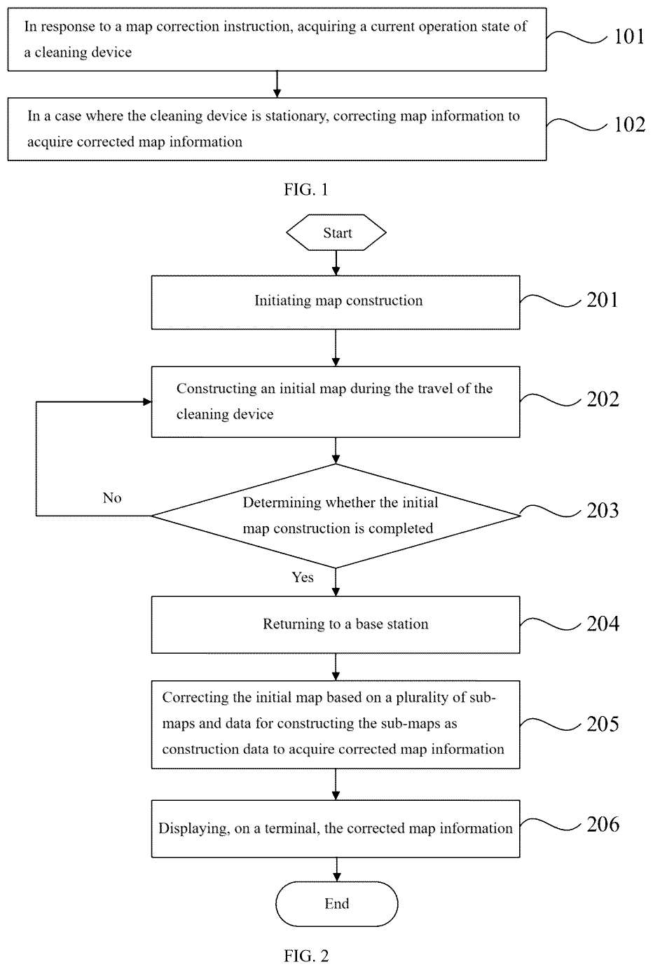

As shown in FIG. 1, according to a first aspect of the embodiments of the present disclosure, a control method for a cleaning device is proposed. The control method for the cleaning device includes the following steps.

In step 101, in response to a map correction instruction, a current operation state of the cleaning device is acquired. It may be understood that the map correction instruction may be issued by a user, for example, in a case where the user recognizes that the constructed map is inaccurate, the user may issue the map correction instruction. The map correction instruction may also be generated by the cleaning device itself. For example, the cleaning device is put into use for the first time, and after the initial map is constructed, the initial map may have errors. In this case, the cleaning device may generate the map correction instruction by itself, and after the cleaning device receives the map correction instruction, the operation state of the cleaning device may be identified.

In step 102, in a case where the cleaning device is stationary, map information is corrected to acquire corrected map information. It may be understood that the cleaning device does not need to navigate and avoid obstacles in the stationary state, leaving its processor basically idle with sufficient computing power available. Therefore, correcting the map information in a case where the cleaning device is in the stationary state has following advantages. Firstly, the map correction efficiency can be improved. Secondly, since map correction is not performed in a case where the cleaning device is moving, but the map information is corrected in a case where the cleaning device is in the stationary state, even if the processor performance of the cleaning device is average, it can still meet the demands of the cleaning device for navigation, obstacle avoidance and map correction, thereby reducing the requirements of the cleaning device for the processor and reducing costs.

According to the control method provided by the embodiments of the present disclosure, in response to the map correction instruction, which indicates potential errors in a current map, the current operation state of the cleaning device is acquired; and in a case where the cleaning device is in the stationary state, the map information is corrected to acquire the corrected map information. Based on this control method provided by the embodiments of the present disclosure, in one aspect, a drifting map can be effectively corrected, such that the map conforms to a real environment; in another aspect, the cleaning device can have a more accurate map during the subsequent operation, which avoids the problems of getting lost, being unable to achieve autonomous recharging, and the like and can ensure the accuracy of subsequent operation and positioning; in still another aspect, map information is not corrected in a case where the cleaning device is moving, thereby being able to effectively ensure navigation and obstacle avoidance effects and lower the requirements of the cleaning device for a processor; and in yet still another aspect, map information is corrected in a case where the cleaning device is in the stationary state, such that the computing power resources of the processor in a case where the cleaning device is moving and operating are not occupied, which can improve the map information correction efficiency and reduce the processor cost. In addition, the map information can be corrected offline and the map can be corrected without user intervention, thereby providing greater autonomy and enhanced user experience.

It may be understood that in a case where the cleaning device is in the stationary state, the cleaning device may be disposed in a base station and is not moving. In this case, the map information can be corrected.

It may be understood that in a case where the cleaning device is stationary, the cleaning device may be in a state in which cleaned components are being cleaned or dried. That is to say, as long as the cleaning device is in the stationary state, even if the cleaned components of the cleaning device are being cleaned or dried, the map information can be corrected. Such an arrangement considers that the cleaning or drying of the cleaned components is achieved through structural components and will not occupy too much computing power of the processor.

In some embodiments, the control method for the cleaning device further includes:
constructing an initial map during the travel of the cleaning device, and the step that, in a case where the cleaning device is stationary, the map information is corrected includes: in a case where the cleaning device is stationary, map information of the initial map is corrected, wherein the initial map is determined based on detection results of an IMU sensor, a wheel odometer and a laser sensor of the cleaning device.

In this technical solution, during the operation, the cleaning device may construct the initial map while performing the cleaning operation. However, due to sensor errors, this initial map may suffer from drift. After the cleaning device completes the initial map construction, in a case where the cleaning device is in the stationary state, the initial map may be corrected to acquire the corrected map information, which can achieve reasonable allocation of the computing power of the processor and reduce the requirements of the cleaning device for the processor.

It may be understood that the control method for the cleaning device provided by the embodiments of the present disclosure is particularly suitable for map construction by a brand-new device or in a case where the cleaning device is operating in a new operating area.

It may be understood that the detection results of the IMU sensor, the wheel odometer and the laser sensor include but are not limited to a travelling distance, position information and traveling direction information of the cleaning device.

In some embodiments, the step that the initial map is constructed during the travel of the cleaning device includes: a plurality of sub-maps is acquired based on the detection results of the IMU sensor, the wheel odometer and the laser sensor; and the initial map is acquired based on the plurality of the sub-maps.

In this technical solution, a method is further provided for the cleaning device to construct the initial map. The initial map may be constructed based on the detection results of the IMU sensor, the wheel odometer and the laser sensor of the cleaning device, i.e., based on at least one portion of information among the traveling distance, the position information and the traveling direction information of the cleaning device during the movement. This can maximize the accuracy of the initial map.

In this technical solution, the plurality of sub-maps is acquired first, and then the plurality of sub-maps is spliced to acquire the initial map. With such an arrangement, in one aspect, the operating area can be divided into a plurality of sub-areas, of which the positioning accuracy is higher than the overall positioning accuracy of the operating area, and thus the accuracy of the initial map can be improved by splicing the plurality of sub-maps to form the initial map; and in another aspect, the initial map is acquired through the plurality of sub-maps, which is conducive to map construction while moving and thus can improve the map construction efficiency.

In some embodiments, the step that the plurality of sub-maps is acquired based on at least one portion of information in the detection results of the IMU sensor, the wheel odometer and the laser sensor includes: an initial pose of the cleaning device is determined based on one portion of information in the detection results of the IMU sensor, the wheel odometer and the laser sensor of the cleaning device; the initial pose is corrected based on the other portion of information of the detection results of the IMU sensor, the wheel odometer and the laser sensor to acquire a corrected pose; and the plurality of sub-maps is drawn based on the corrected pose and the detection result of the laser sensor.

In this technical solution, the step of acquiring the plurality of sub-maps is further provided: the initial pose of the cleaning device may be determined based on one portion of information in the detection results of the IMU sensor, the wheel odometer and the laser sensor; and based on the other portion of information in the detection results of the IMU sensor, the wheel odometer and the laser sensor, the initial pose is corrected to acquire the corrected pose, that is to say, the initial pose may be acquired first, and then the initial pose is corrected to acquire the corrected pose; and next, the sub-maps are acquired based on the corrected pose and the detection result of the laser sensor, which can improve the accuracy of the sub-maps.

It may be understood that the initial pose and the corrected pose each may include a traveling distance and a traveling direction of the cleaning device.

By taking that the cleaning device includes the laser sensor, the IMU sensor, the wheel odometer and other sensors as an example, during the acquisition of the sub-maps, the initial pose of the cleaning device is acquired by performing forward integration on the trajectory of the cleaning device based on the detection results of the IMU sensor and the wheel odometer. The initial pose is further optimized with observation data from the laser sensor to acquire the corrected pose. The corrected pose may be considered as a current pose of the cleaning device. It may be understood that due to interference of various noises, the measurement values of the sensor are not exact, so the corrected pose estimated in the above process also contains certain noise. This causes the pose drifting of the cleaning device over time.

Furthermore, a new sub-map may be generated based on the corrected pose at every time interval, and adjacent sub-maps are overlapped with each other and each sub-map has its own pose. A relative pose of the current laser observation with respect to the sub-map is acquired based on the corrected pose and a pose of the current sub-map. Then, with this relative pose, a point cloud observed by the current laser sensor is transformed into a coordinate system of the current sub-map and integrated into the current sub-map. The plurality of sub-maps may be spliced according to the poses of the sub-maps to acquire the initial map. Although the sensor has noise, the noise is so small that the pose errors estimated over short periods are also very small. Therefore, the map within each sub-map may be considered accurate and drift-free. However, during extended operation, the poses drift, meaning that the poses of the sub-maps also slowly drift. The initial map spliced based on the poses of all sub-maps will also drift accordingly, resulting in inconsistency between the initial map and the real environment. Therefore, in the control method provided by the embodiments of the present disclosure, the pose of each sub-map is corrected and the sub-maps with corrected poses are spliced again, such that corrected map information that better conforms to the real environment can be acquired, thereby improving the subsequent operation accuracy of the cleaning device.

It may be understood that the initial map may also be acquired through a laser simultaneous localization and mapping (SLAM)-based approach and/or a filtering-based positioning approach.

It may be understood that the pose of the sub-map includes the coordinates and direction of the sub-map within the initial map.

In some embodiments, the step that, in a case where the cleaning device is stationary, the map information is corrected includes: in a case where the cleaning device is stationary, raw data information of the cleaning device during initial map construction is acquired; and the initial map is corrected based on the raw data information to acquire the corrected map.

In this technical solution, a specific method for correcting the initial map is further provided, and the raw data information may be acquired. For example, based on the detection results of the IMU sensor, the wheel odometer and the laser sensor, i.e., the travelling distance, position information and traveling direction information which are collected during the movement of the cleaning device, the initial map is corrected, thereby reducing map errors, ensuring the map accuracy, and acquiring the corrected map.

In some embodiments, the step that, in a case where the cleaning device is stationary, the map information is corrected includes: in a case where the cleaning device is stationary, raw data information of the cleaning device during initial map construction is acquired; and based on the raw data information, corresponding relationships among the plurality of sub-maps are verified; and based on the corresponding relationships, poses of the sub-maps in the initial map are corrected to acquire the corrected map.

In this technical solution, specific steps for correcting the initial map are further provided. The raw data information for constructing the initial map may be collected. Further, the corresponding relationship between two different sub-maps may be determined based on the raw data information. Since this corresponding relationship is determined based on the raw data, it may be considered that this corresponding relationship is accurate. Therefore, the pose of each sub-map may be adjusted based on the corresponding relationship to correct the initial map, such that the corrected map information conforms more to the real environment, which is conducive to the subsequent accurate positioning of the cleaning device.

In some embodiments, the corresponding relationships among the plurality of sub-maps include odometry constraints and loop-closure constraints, wherein the odometry constraints are relative positional relationships between adjacent sub-maps; and the loop-closure constraints are relative pose relationships between non-adjacent sub-maps.

In this technical solution, the styles and types of corresponding relationships are further provided. The corresponding relationships include odometry constraints and loop-closure constraints. The odometry constraints can prevent the poses of the sub-maps from being optimized to unreasonable positions during optimization, thereby avoiding significant deviations in the optimized map, and the loop-closure constraints can correct accumulated errors. In the control method for the cleaning device provided by the embodiments of the present disclosure, map information is primarily corrected through the loop-closure constraints and the correction accuracy is controlled through the odometry constraints.

In some embodiments, the step that the corresponding relationships of the loop-closure constraints among the plurality of sub-maps are verified based on the raw data information includes: all sub-maps are traversed, and each sub-map is matched with its non-adjacent sub-maps respectively; and if the matching is successful, a corresponding relationship between the two non-adjacent sub-maps is acquired.

In this technical solution, a specific method for determining the corresponding relationships of the loop-closure constraints is further provided. Matching may be performed on two non-adjacent sub-maps; and if the pose relationship between any two non-adjacent sub-maps among the plurality of sub-maps is matched in the raw data, the pose relationship between these two sub-maps may be considered as the corresponding relationship of the loop-closure constraints. The pose relationship between these two sub-maps is accurate and extremely close to the real environment.

In some embodiments, the step that each sub-map is matched with its non-adjacent sub-maps respectively includes: raw data contained in one of the sub-maps is acquired from the raw data and matching is performed on another sub-map with this raw data.

By taking the plurality of sub-maps arranged consecutively, numbered 1, 2, 3 . . . n, n+1 as an example, when these n+1 sub-maps are matched with each other (adjacent sub-maps are not matched), it is found that sub-map 2 and sub-map n are successfully matched, and the relative pose relationship between sub-map 2 and sub-map n is acquired. Therefore, the aforementioned relative pose relationship between sub-map 2 and sub-map n may be considered as being accurate. Thus, the poses of sub-maps 3 to n within the initial map may be adjusted based on the relationship between sub-map 2 and sub-map n, enabling the poses of sub-maps 3 to n to conform more closely to the real environment.

In some embodiments, a plurality of corresponding relationships is provided, and the step that the pose of the sub-map in the initial map is corrected based on the corresponding relationship to acquire the corrected map includes: based on each corresponding relationship, the poses of all sub-maps between the two sub-maps are corrected to acquire the corrected map.

In this technical solution, considering that the plurality of sub-maps is provided, the plurality of corresponding relationships may exist among the plurality of sub-maps. The initial map is corrected based on the plurality of corresponding relationships, which can further improve the accuracy of the corrected map.

Similarly, by taking the cleaning device including the laser sensor, the IMU sensor, the wheel odometer and other sensors as an example, in a case where the map information is corrected, during the operation of the cleaning device, each sub-map and raw data information for constructing the sub-map are saved.

After the cleaning device completes the initial map construction, the cleaning device returns to a base station. At this time, the cleaning device is stationary, there is no need to calculate a real-time pose of the cleaning device and to process the data required for movement, and the processor is in a relatively idle state. Thus, during this period of time, the initial map can be corrected. The specific method is as follows.

All sub-maps are traversed and matching is performed on each sub-map with its non-adjacent sub-map. If the two sub-maps are matched successfully, a corresponding relationship is established, which is a loop-closure constraint. After the traversal is completed, a plurality of loop-closure constraints is successfully constructed. By adjusting the poses of the sub-maps through the plurality of loop-closure constraints, the initial map can be corrected. Based on this, a least-squares optimization problem can be constructed to continuously optimize the poses of the sub-maps, thereby minimizing the overall error of the corrected map information.

In some embodiments, the control method for the cleaning device further includes: during the travel of the cleaning device, storing each sub-map for constructing the initial map; and/or during the travel of the cleaning device, storing raw data information for constructing the initial map at each time interval.

In this technical solution, during the travel of the cleaning device, the sub-maps may be stored for subsequent correction of the initial map.

During the operation and movement of the cleaning device, the raw data information for constructing the initial map may also be stored at each time interval to enrich the raw data information and facilitate subsequent correction of the initial map.

In some embodiments, the control method for the cleaning device further includes:
sending corrected map information to a terminal. With such an arrangement, the corrected map information may be stored and displayed through the terminal, such that the user can more intuitively observe the map constructed by the cleaning device. Thus, in one aspect, if the map has errors, the user can find them punctually; and in another aspect, it is convenient for the user to set the map and choose different cleaning modes for different areas in the map, thereby improving user satisfaction.

In some embodiments, the control method for the cleaning device further includes: after the initial map construction is completed, a current operation state of the cleaning device is acquired; or after the cleaning device returns to a base station, a current operation state of the cleaning device is acquired.

In this technical solution, the current operation state of the cleaning device is acquired after the initial map construction is completed, or the current operation state of the cleaning device is acquired after the cleaning device returns to the base station. Such an arrangement facilitates clear definition of an execution time for map correction, such that the cleaning device can autonomously correct the map information, which can further improve the user experience.

As shown in FIG. 2, in some examples, the control method for the cleaning device includes:
step 201, initiating map construction;
step 202, constructing an initial map during the travel of the cleaning device;
step 203, determining whether the initial map construction is completed;
step 204, returning to a base station;
step 205, correcting the initial map based on a plurality of sub-maps and data for constructing the sub-maps as construction data to acquire corrected map information; and
step 206, displaying, on a terminal, the corrected map information.

Based on this control method for the cleaning device provided by the embodiments of the present disclosure, in one aspect, a drifting map can be effectively corrected, such that the corrected map information conforms to a real environment; in another aspect, the accuracy of the subsequent positioning and operation of the cleaning device on the existing map is effectively ensured; in still another aspect, navigation effects of the cleaning device are effectively ensured and the sufficient computing power of the processor is ensured, thereby avoiding the problems of getting lost, being unable to achieve autonomous recharging, and the like; and in yet still another aspect, during the map correction, the computing power resources of the processor in a case where the cleaning device is operating are not occupied, such that a low-cost processor (CPU) can be used. In addition, the map can be updated without user intervention, thereby enhancing the user experience.

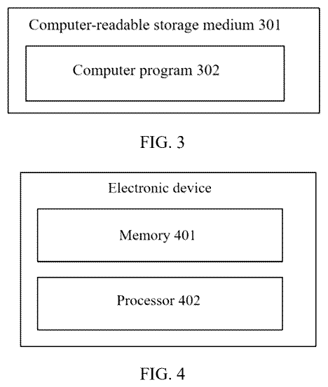

As shown in FIG. 3, according to a third aspect of the embodiments of the present disclosure, a computer-readable storage medium 301 is proposed. The computer-readable storage medium 301 stores a computer program 302 to implement the control method according to any of the above technical solutions.

The computer-readable storage medium 301 provided by the embodiments of the present disclosure implements the control method according to any of the above technical solutions and thus has all the beneficial effects of the control method according to any of the above technical solutions.

According to the computer-readable storage medium 301 provided by the embodiments of the present disclosure, in response to the map correction instruction, which indicates potential errors in a current map, the current operation state of the cleaning device is acquired; and in a case where the cleaning device is in the stationary state, the map information is corrected to acquire the corrected map information. Based on this control method provided by the embodiments of the present disclosure, in one aspect, a drifting map can be effectively corrected, such that the map conforms to a real environment; in another aspect, the cleaning device can have a more accurate map during the subsequent operation, which can ensure the accuracy of subsequent operation and positioning; in still another aspect, map information is not corrected in a case where the cleaning device is moving, thereby being able to effectively ensure navigation effects, avoiding the problems of getting lost, being unable to achieve autonomous recharging, and the like, and lowering the requirements of the cleaning device for the processor; and in yet still another aspect, map information is corrected in a case where the cleaning device is in the stationary state, such that the computing power resources of the processor in a case where the cleaning device is moving and operating are not occupied, which can improve the map information correction efficiency and reduce the processor cost. In addition, the map information can be corrected offline and the map can be corrected without user intervention, thereby providing greater autonomy and enhanced user experience.

Based on this understanding, the technical solution of the present disclosure may be embodied in the form of a software product. The software product may be stored in a non-volatile storage medium (which may be a CD-ROM, a USB flash drive, a mobile hard disk, etc.) and includes a number of instructions to cause a computer device (which may be a personal computer, a server, or a network device, etc.) to execute the method of each implementation scenario in the present disclosure.

As shown in FIG. 4, according to a fourth aspect of the embodiments of the present disclosure, a cleaning device is proposed. The cleaning device includes a memory 401 configured to store a computer program; and a processor 402 configured to execute the computer program. The processor 402, when executing the computer program, implements the control method according to any of the above technical solutions.

The cleaning device provided by the embodiments of the present disclosure implements the control method according to any of the above technical solutions and thus has all the beneficial effects of the control method according to any of the above technical solutions.

According to the cleaning device provided by the embodiments of the present disclosure, in response to the map correction instruction, which indicates potential errors in a current map, the current operation state of the cleaning device is acquired; and in a case where the cleaning device is in the stationary state, the map information is corrected to acquire the corrected map information. Based on this control method provided by the embodiments of the present disclosure, in one aspect, a drifting map can be effectively corrected, such that the map conforms to a real environment; in another aspect, the cleaning device can have a more accurate map during the subsequent operation, which can ensure the accuracy of subsequent operation and positioning; in still another aspect, map information is not corrected in a case where the cleaning device is moving, thereby being able to effectively ensure navigation effects, avoiding the problems of getting lost, being unable to achieve autonomous recharging, and the like, and lowering the requirements of the cleaning device for the processor; and in yet still another aspect, map information is corrected in a case where the cleaning device is in the stationary state, such that the computing power resources of the processor in a case where the cleaning device is moving and operating are not occupied, which can improve the map information correction efficiency and reduce the processor cost. In addition, the map information can be corrected offline and the map can be corrected without user intervention, thereby providing greater autonomy and enhanced user experience.

In some examples, the cleaning device may also include a user interface, a network interface, a camera, a radio frequency (RF) circuit, a sensor, an audio circuit, a WI-FI module, etc. The user interface may include a display screen, an input unit such as a keyboard, etc. Optionally, the user interface may also include a USB interface, a card reader interface, etc. The network interface may include a standard wired interface, a standard wireless interface (such as a WI-FI interface), etc.

In an exemplary embodiment, the cleaning device may also include an input/output interface and a display device. Various functional units may communicate with each other through a bus. The memory stores a computer program, and the processor is configured to execute the program stored in the memory to execute the method in the above embodiment.

The above storage medium may also include an operating system and a network communication module. The operating system is a program that manages hardware and software resources of an entity device in the above method and supports the running of information processing programs and other software and/or programs. The network communication module is configured to achieve communication between components within the storage medium, as well as communication with other hardware and software in an information processing entity device.

Through the above description of the embodiments, those skilled in the art can clearly understand that the present disclosure can be implemented by means of software and a necessary general hardware platform, or can also be implemented by hardware.

The present disclosure is described with reference to the flowcharts and/or block diagrams of methods, devices (systems), and computer program products according to the embodiments of the present disclosure. It should be understood that each process and/or block in the flowcharts and/or block diagrams, and combinations of processes and/or blocks in the flowcharts and/or block diagrams, may be implemented by the computer program instructions. These computer program instructions may be provided to a processor of a general-purpose computer, a special-purpose computer, an embedded computer, or other programmable data processing device to produce a machine, such that the instructions executed by the processor of the computer or other programmable data processing device produce means for implementing the functions specified in a process or processes of a flowchart and/or a block or blocks of a block diagram.

According to a fourth aspect of the embodiments of the present disclosure, a cleaning system is proposed. The cleaning system includes the cleaning device according to the above technical solution; and a cleaning base station that provides maintenance for the cleaning device.

The cleaning system provided by the embodiments of the present disclosure includes the cleaning device of the above technical solution and thus has all the beneficial effects of the cleaning device according to the above technical solution, which will not be repeated here.

It may be understood that the cleaning base station can clean mop cloth of the cleaning device and/or charge the cleaning device.

It may be understood that the cleaning device may also include a laser sensor, an IMU sensors and a wheel odometer.

In the present disclosure, the terms “first”, “second” and “third” are only for the purpose of description and should not be construed as indicating or implying relative importance. The term “a plurality of” means two or more, unless otherwise expressly defined. The terms “install”, “connected with”, “connected to”, “fixed” and the like should be understood broadly. For example, the term “connection” may refer to a fixed connection, a detachable connection or an integrated connection; and the term “connected with” may refer to directly connected or indirectly connected via an intermediate medium. For those of ordinary skill in the art, specific meanings of the foregoing above terms in the present disclosure may be understood based on specific situations.

In the description of the present disclosure, it should be understood that the orientation or positional relationships indicated by the terms such as “upper”, “lower”, “left”, “right”, “front” and “rear” are orientation or positional relationships shown based on the drawings, and are merely for the purposes of describing the present disclosure and simplifying the description, rather than indicating or implying that the apparatus or unit referred to must have a specific direction, or must be configured and operated in a specific orientation, Therefore, these terms should not be understood as limitations to the present disclosure.

In the description, the description of the terms “an embodiment”, “some embodiments”, “specific embodiments” and the like means that specific features, structures, materials or characteristics described in conjunction with the embodiment(s) or example(s) are included in at least one embodiment or example of the present disclosure. In the present description, the illustrative expressions of the above terms do not necessarily refer to the same embodiments or examples. Moreover, the specific features, structures, materials or characteristics described may be combined in any one or more embodiments or examples in any suitable manner.

Described above are only preferred embodiments of the present disclosure, but are not intended to limit the present disclosure. Various changes and modifications may be made to the present disclosure for those skilled in the art. Any modifications, equivalent substitutions, improvements, etc. made within the spirit and principles of the present disclosure are included within the protection scope of the present disclosure.

1. A control method for a cleaning device, comprising:
acquiring a current operation state of the cleaning device; and
in a case where the cleaning device is stationary, correcting map information to acquire corrected map information.

2. The control method for the cleaning device according to claim 1, further comprising:
constructing an initial map during the travel of the cleaning device, and the step of, in a case where the cleaning device is stationary, correcting the map information comprises:
in a case where the cleaning device is stationary, correcting map information of the initial map, wherein
the initial map is determined based on detection results of an IMU sensor, a wheel odometer and a laser sensor of the cleaning device.

3. The control method for the cleaning device according to claim 2, wherein the step of constructing the initial map during the travel of the cleaning device comprises:
acquiring a plurality of sub-maps based on at least one portion of information in the detection results of the IMU sensor, the wheel odometer, and the laser sensor; and
acquiring the initial map based on the plurality of sub-maps.

4. The control method for the cleaning device according to claim 3, wherein the step of acquiring the plurality of sub-maps based on at least one portion of information in the detection results of the IMU sensor, the wheel odometer and the laser sensor comprises:
determining an initial pose of the cleaning device based on one portion of information in the detection results of the IMU sensor, the wheel odometer and the laser sensor of the cleaning device;
correcting the initial pose based on the other portion of information in the detection results of the IMU sensor, the wheel odometer and the laser sensor to acquire a corrected pose; and
drawing the sub-maps based on the corrected pose and the detection result of the laser sensor.

5. The control method for the cleaning device according to claim 2, wherein the step of, in a case where the cleaning device is stationary, correcting the map information comprises:
in a case where the cleaning device is stationary, acquiring raw data information of the cleaning device during initial map construction; and
correcting the initial map based on the raw data information to acquire the corrected map.

6. The control method for the cleaning device according to claim 3, wherein the step of, in a case where the cleaning device is stationary, correcting the map information comprises:
in a case where the cleaning device is stationary, acquiring raw data information of the cleaning device during initial map construction;
based on the raw data information, verifying corresponding relationships among the plurality of sub-maps; and
based on the corresponding relationships, correcting poses of the sub-maps in the initial map to acquire the corrected map.

7. The control method for the cleaning device according to claim 6, wherein
the corresponding relationships among the plurality of sub-maps comprise odometry constraints and loop-closure constraints, wherein
the odometry constraints are relative positional relationships between adjacent sub-maps; and
the loop-closure constraints are relative pose relationships between non-adjacent sub-maps.

8. The control method for the cleaning device according to claim 6, wherein the step of, based on the raw data information, verifying the corresponding relationships among the plurality of sub-maps comprises:
traversing all the sub-maps, and matching each sub-map with its non-adjacent sub-maps respectively; and if the matching is successful, acquiring a corresponding relationship between two non-adjacent sub-maps.

9. The control method for the cleaning device according to claim 8, wherein the step of matching each sub-map with its non-adjacent sub-maps respectively comprises:
acquiring raw data contained in one of the sub-maps from the raw data and performing matching on another sub-map with the raw data.

10. The control method for the cleaning device according to claim 6, wherein a plurality of corresponding relationships are provided, and the step of, based on the corresponding relationships, correcting the poses of the sub-maps in the initial map to acquire the corrected map comprises:
based on each corresponding relationship, correcting the poses of all the sub-maps between two sub-maps to acquire the corrected map.

11. The control method for the cleaning device according to claim 1, further comprising:
during the travel of the cleaning device, storing each sub-map for constructing the initial map; and/or
during the travel of the cleaning device, storing raw data information for constructing the initial map at each time interval; and/or
sending the corrected map information to a terminal.

12. The control method for the cleaning device according to claim 1, further comprising:
after the initial map construction is completed, acquiring a current operation state of the cleaning device; or
after the cleaning device returns to a base station, acquiring a current operation state of the cleaning device.

13. A non-transitory computer-readable storage medium, wherein
the non-transitory computer-readable storage medium stores a computer program to implement the following operations:
acquiring a current operation state of the cleaning device; and
in a case where the cleaning device is stationary, correcting map information to acquire corrected map information.

14. A cleaning device, comprising:
a memory, configured to store a computer program; and
a processor, configured to execute the computer program, wherein
the processor, when executing the computer program, implements the following operations:
acquiring a current operation state of the cleaning device; and
in a case where the cleaning device is stationary, correcting map information to acquire corrected map information.

15. The cleaning device according to claim 14, wherein the processor, when executing the computer program, further implements the following operations:
constructing an initial map during the travel of the cleaning device, and the step of, in a case where the cleaning device is stationary, correcting the map information comprises:
in a case where the cleaning device is stationary, correcting map information of the initial map, wherein
the initial map is determined based on detection results of an IMU sensor, a wheel odometer and a laser sensor of the cleaning device.

16. The cleaning device according to claim 15, wherein the step of constructing the initial map during the travel of the cleaning device comprises:
acquiring a plurality of sub-maps based on at least one portion of information in the detection results of the IMU sensor, the wheel odometer, and the laser sensor; and
acquiring the initial map based on the plurality of sub-maps.

17. The cleaning device according to claim 16, wherein the step of acquiring the plurality of sub-maps based on at least one portion of information in the detection results of the IMU sensor, the wheel odometer and the laser sensor comprises:
determining an initial pose of the cleaning device based on one portion of information in the detection results of the IMU sensor, the wheel odometer and the laser sensor of the cleaning device;
correcting the initial pose based on the other portion of information in the detection results of the IMU sensor, the wheel odometer and the laser sensor to acquire a corrected pose; and
drawing the sub-maps based on the corrected pose and the detection result of the laser sensor.

18. The cleaning device according to claim 15, wherein the step of, in a case where the cleaning device is stationary, correcting the map information comprises:
in a case where the cleaning device is stationary, acquiring raw data information of the cleaning device during initial map construction; and
correcting the initial map based on the raw data information to acquire the corrected map.

19. The cleaning device according to claim 16, wherein the step of, in a case where the cleaning device is stationary, correcting the map information comprises:
in a case where the cleaning device is stationary, acquiring raw data information of the cleaning device during initial map construction;
based on the raw data information, verifying corresponding relationships among the plurality of sub-maps; and
based on the corresponding relationships, correcting poses of the sub-maps in the initial map to acquire the corrected map.

20. A cleaning system, comprising:
the cleaning device according to claim 14; and
a cleaning base station that provides maintenance for the cleaning device.
